(19) United States
(12) Patent Application Publication
(10) Pub. No.: US 2005/0246225 A1
(43) Pub. Date: Nov. 3, 2005

(54) Method, system, reverse vending machine and use thereof for handling empty packaging

(75) Inventor: Anders Jorgensen, Drammen (NO)

Correspondence Address: RODMAN RODMAN, 7 SOUTH BROADWAY, WHITE PLAINS, NY, 10601, US

(73) Assignee: Tomra systems asa, Asker (NO)

(21) Appl. No.: 10/520,297

(22) PCT Filed: Jul. 4, 2003
(86) PCT No.: PCT/NO03/00234

§ 371 Date: Dec. 30, 2004

(30) Foreign Application Priority Data
Jul. 5, 2002 (NO) 20023263

(51) Int. Cl. G06F 17/60

(52) U.S. Cl. 705/14

(57) ABSTRACT

A method and system for handling, through the use of a reverse vending machine, the return value of empty packaging, e.g., empty packaging in the form of bottles, cans and containers for beverages and food, wherein the reverse vending machine before or after receiving the empty packaging has a means for allowing the customer to indicate either by pressing a first switch that a receipt should be issued related to the return value of the empty packaging for a subsequent refund in cash from the empty packaging recipient, or by pressing a second switch that the return value of the empty packaging is to be used for participation in a lottery. Information elements are transferred from the reverse vending machine to a central database server, and on the basis of these elements the database server issues a number of lottery tickets together with a unique lottery ticket serial number as some of the information elements sent back to the reverse vending machine, whereupon on confirmation of purchase, a lottery ticket is issued by a printer in the reverse vending machine.

The present invention relates to a method for handling empty packaging as disclosed in the preamble of claims 1, 2, 4 and 5, a system for handling empty packaging as disclosed in the preamble of claims 11, 12, 14 and 15, a vending machine as disclosed in claim 20, and a use as disclosed in claims 22 and 23.

It is already known to handle, through the use of a reverse vending machine, the return deposit for empty packaging, e.g., empty packaging in the form of bottles, cans and containers for beverages and foods, wherein the reverse vending machine after receiving the empty packaging has a means for allowing the customer to indicate either by pressing a first switch that a receipt relating to the return deposit value of the empty packaging should be issued for a subsequent refund in cash from the recipient of the empty packaging, or by pressing a second switch that the return deposit value of the empty packaging should be used in another way, i.e., a donation to one or more charitable or public causes.

Unfortunately, the option of choosing a donation has not proven to be an unqualified success, and it is a fact that the number of empty beverage bottles and cans not returned for reuse or remelting is still all too high.

For many years, the inhabitants of Norway have been used to the system of a deposit on beverage packaging, and most people live in the belief that everyone is good at returning empty packaging after use, for the benefit of the environment. The fact is that in 2001 almost 80 million bottles and cans disappeared from the return system. These units were purchased, but never returned, and 2001 was not unique. The non-return of empty packaging has been remarkably stable for many years, and the authorities have an avowed objective to reduce the fees on beverage packaging when the deposit packaging percentage of all packaging reaches 95%. Nevertheless, today's numbers of non-returned packaging can be expressed in a concrete form to illustrate the scale of the problem.

If all non-returned units were placed upright side by side they would form a 5000 kilometre long chain. This corresponds to ten times the distance by road between Oslo and Trondheim. Alternatively, if all the units were loaded in semi-trailers (18 metres), the caravan would consist of a minimum of 900 trailers. If actual sizes (proportion of large deposit units) are taken into account, the number would probably rise to more than 1100. The convoy would be about 20 kilometres long.

Thus, the object of the present invention is to contribute to: an increase in the return of empty packaging, which has a clear environmental aspect; an increase in the desire to return empty packaging because it provides possibilities for gains in addition to the refund due on the empty packaging; and contributions to charitable organisations or public causes. The present invention thus relates not only to the empty packaging that the customer has initially paid a deposit for and expects to have refunded when he returns the empty packaging, but also to empty packaging that qualifies for a return value governed by, for example, a weight value of metal in general, certain types of metal, glass and/or plastic, and, for example, a return value linked solely to environmental measures and where, for instance, a nominal refund is paid per inserted unit.

Although the following description focuses in particular on the use of the present invention in connection with bottles and cans for beverages, and where the customer has paid a deposit that is to be refunded when the empty packaging is returned, it will immediately be appreciated that the invention can be used for empty packaging on which the customer has not paid a deposit, but where it is nevertheless desirable to have such packaging returned. The term “return value” thus applies to empty packaging with or without a prepaid deposit.

The term “reverse vending machine” is understood to mean in the context of the present invention that can receive and handle empty packaging whether it is deposit-bearing or not, as empty non-deposit packaging can in any case be awarded by a device of this kind a return value according to certain criteria as indicated above.

According to the invention, the method is characterised by the features set forth in attached claims 1, 2, 4 and 5, and associated sub-claims.

According to the invention, the system is characterised by the features set forth in attached claims 11, 12, 14 and 15, and associated sub-claims.

The reverse vending machine is characterised, according to the invention, by the features set forth in claim 20, and sub-claim 21 associated therewith.

The use, according to the invention, is set forth in attached claims 22 and 23.

The invention will now be described in more detail, also with reference to the attached figures.

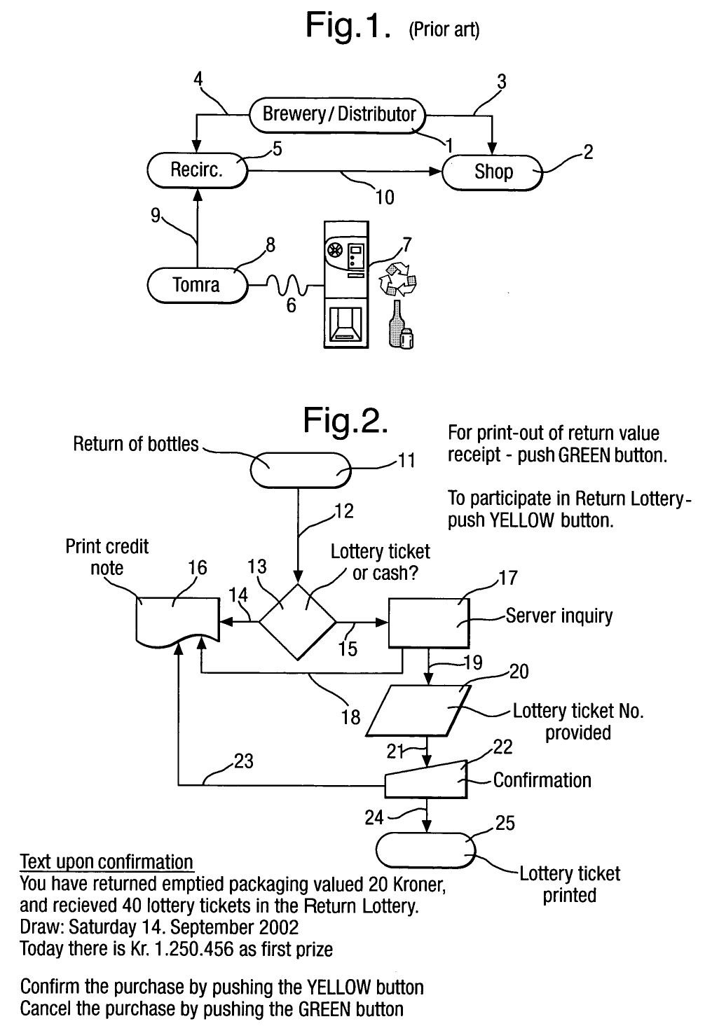

FIG. 1 shows the existing flow of deposit money in a deposit-return system.

FIG. 2 is a conceptual indication of operations that are necessary for the choice of a standard receipt for a refund in cash of the return value or a lottery ticket in a “Lottery”.

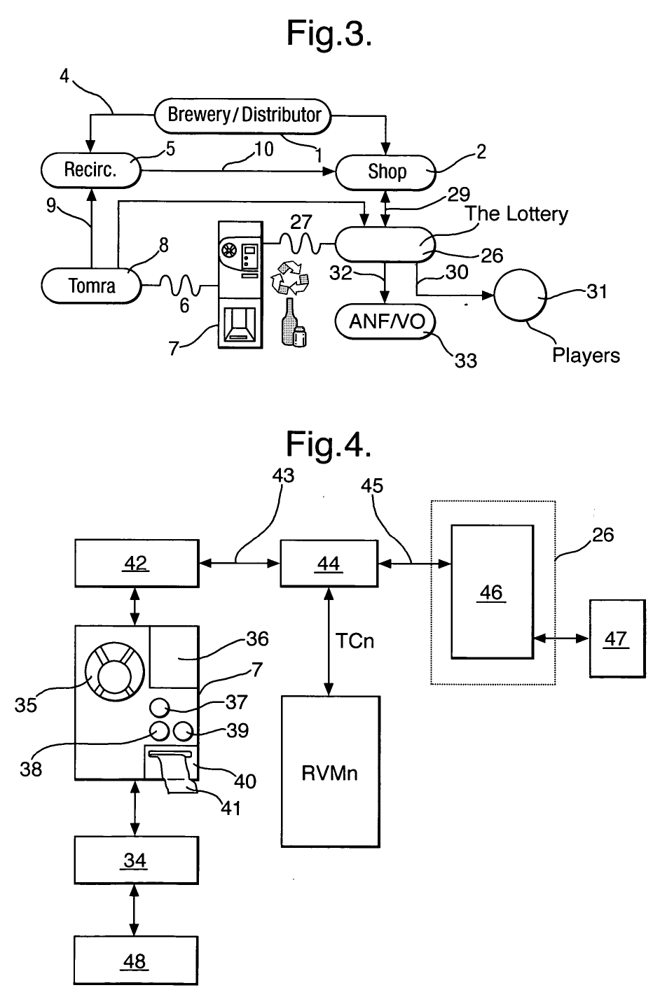

FIG. 3 shows the flow of deposit money in a deposit-return system of which the present invention may be an integral part.

FIG. 4 is a block diagram of the structure of the system for handling the issuing of lottery tickets in connection with the use of a reverse vending machine, according to the invention.

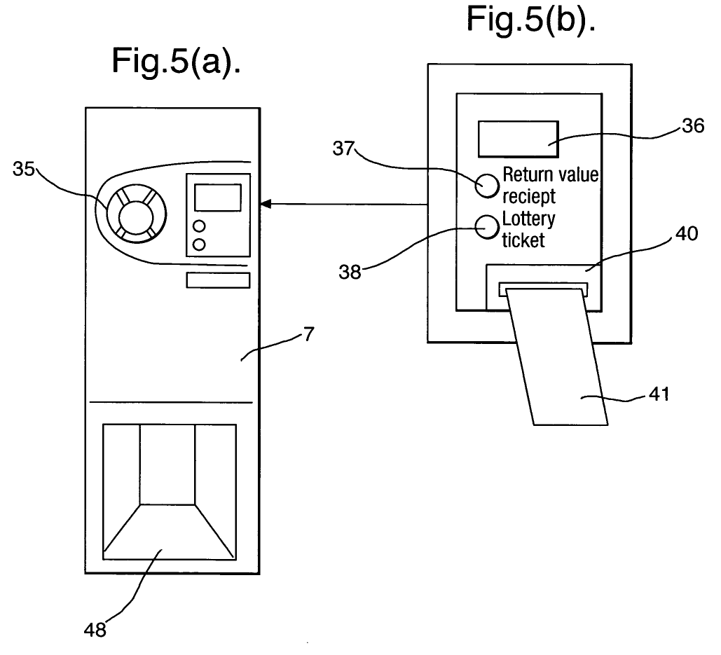

FIG. 5a and FIG. 5b show an animation of an external modification of an existing reverse vending machine for implementation of the invention.

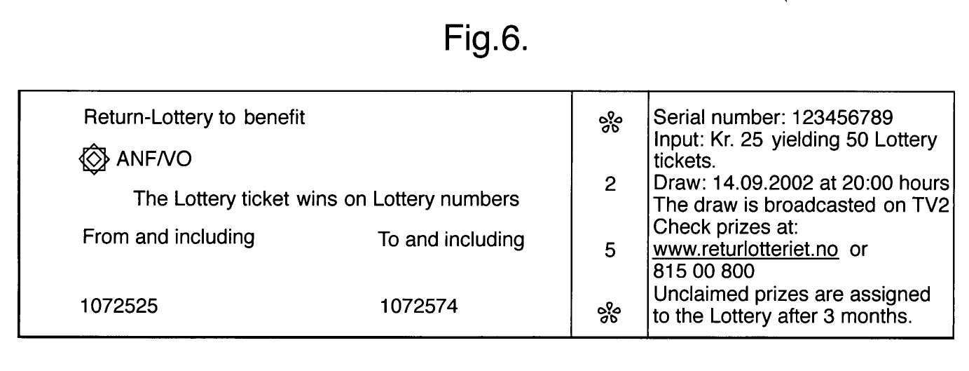

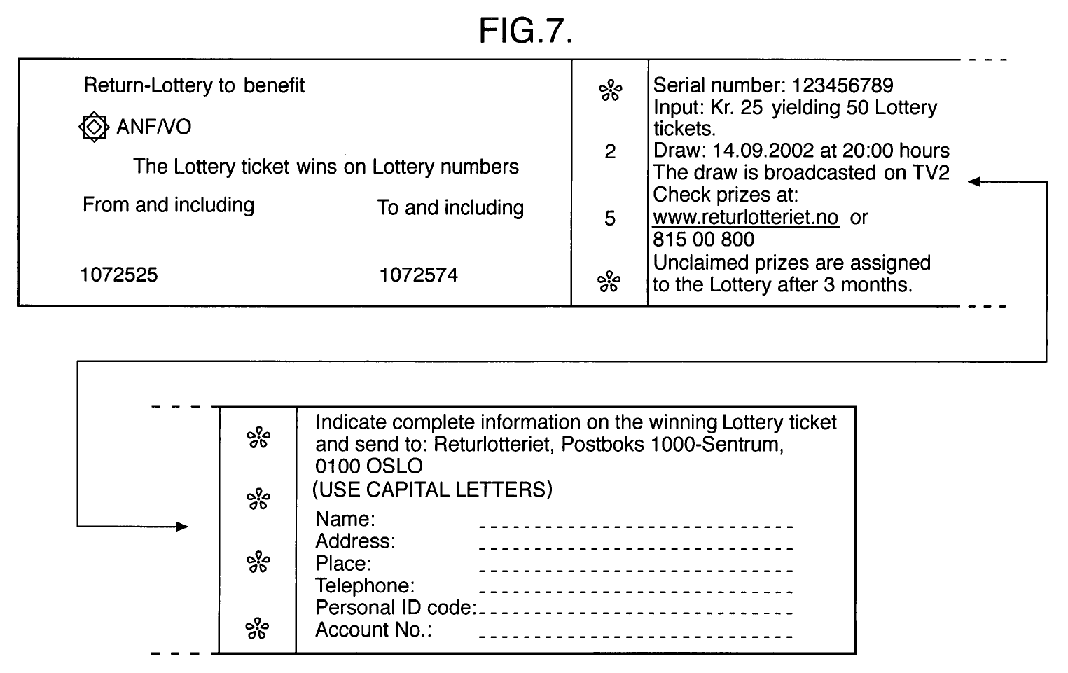

FIGS. 6 and 7 show typical, non-limiting exemplary embodiments of lottery tickets.

FIG. 1 shows how the brewery or distributor 1 of the individual product sells it to the shop 2 and invoices 3 the shop 2 for deposits on the beverage packaging. The brewery or distributor 1 keeps the money that is collected from the shop 2 for reusable packaging (plastic and glass that can be reused for the same purpose), but pays 4 the deposits that are collected for cans and PET packaging to a recycling plant “Recyc” 5. The shop sells all the beverage packaging plus deposits and refunds the deposits to the customer when the beverage packaging is returned. When, in the next stage, the shop then returns the reusable packaging to the brewery or importer, the deposits will be credited to the shop.

In the case of cans and PET packaging, the shops are refunded the money by “Recyc”. Information 6 is regularly downloaded from the reverse vending machine 7 via an intermediary 8., e.g., Tomra Systems ASA, and is transferred 9 in a processed form to Recyc. 5. Settlement 10 is sent from “Recyc.” to the shop 2.

The object of the present invention is that the customer, on delivering empty packaging, is to be able to choose whether the return value should be paid in the form of a refund in cash or be used to participate in a lottery, known as, for example, “the Deposit Lottery” or “the Return Lottery”. In the following this is referred to simply as “the Lottery”.

There is reason to suppose that the proportion of empty packaging returned will increase substantially as a consequence of such a Lottery. The motivation for returning empty packaging will be greater, as the Lottery will help to increase the psychological value associated with the return value, for example, the deposit. What today is “just a bottle or a can” or return value slip, e.g., a deposit slip, will be upgraded to a possible winner chance.

The percentage of reusable packaging returned today is 95%, whilst for cans it is 87% and 65% for PET bottles. There are no statistics that tell us what has become of the bottles and cans that are not returned, but there is reason to believe that they end their days in the refuse disposal system where they take up a good deal of space, or end up littering the countryside. If the Lottery helps to increase the percentage of returned empties by just 1%, it will mean 800,000 fewer bottles and cans on refuse tips and in the countryside, which of course provides a clear environmental benefit.

Apart from the fact that the Lottery will in all probability make a positive contribution to the financing of the work of public causes or charitable organisations, there is another major winner in this concept that is not found in any other lottery concept as far as is known, namely the environment.

In addition to the value such a lottery would have for public or charitable causes, there is a secondary, but nevertheless very important motivation for starting up the Lottery, namely the benefits for the environment through:
Increased motivation for the public to return more empty packaging;
Less waste and thus a reduced load on the refuse disposal system;
An increase in percentage of return packaging and thus the possibility of reducing fees on beverage packaging.

In the Lottery, the basic principle is that the player (the customer returning empty packaging) is to use empty bottles, empty cans or crates that are sent through reverse vending machines as a stake on the lottery, instead of the traditional purchase of lottery tickets using coins or banknotes. When a customer uses a reverse vending machine for returning empty packaging such as bottles or cans (whether they have a deposit value or not), this customer will be presented with questions in a display on the machine about whether he or she wishes to use the refund given for the return of the empty packaging as a stake on a lottery, or whether he or she would like to have a receipt issued in the usual way for a refund in cash. It will be essential that this option is not perceived as offensive by the customer, but appears as an invitation (or challenge). The physical design of the reverse vending machine will be such that the customer will be in no doubt as to how he can take out the usual return value receipt without taking part in the lottery.

The practical implementation of the concept means in brief outline that already existing reverse vending machines will have to be remodelled slightly both externally (the visual appearance seen by the customer) and internally (software/hardware) to permit the implementation of the Lottery.

The external remodelling will be noticed by the customer primarily because hereafter there will be two buttons to press, i.e., e.g., either a green button that gives a return value receipt in the usual way, or a yellow button which will give lottery tickets for the Lottery. The normal display on the reverse vending machine is used to communicate with the customer. It is of course important that the purchase of lottery tickets should be made as a result as a conscious action.

Most people have at some time returned bottles in a reverse vending machine and know how this is done. As shown, the idea with the Lottery is that after returning bottles 11, the customer should be presented with a question 12 on the display of the reverse vending machine about whether he or she wishes to stake the sum on the Lottery. The customer chooses the right button represented by decision block 13, i.e., “normal” deposit receipt represented by 14 and lottery ticket represented by 15.

If the customer does not wish to play the Lottery (i.e., answers NO to the question), then by implication the customer wishes to be given his usual return value receipt, for example, a deposit value receipt, that is to be printed out 16. This requires the customer to press a green button as usual, and this is a method with which the customer is already familiar. If, on the other hand, the customer wishes to stake the return value sum on the Lottery (i.e., he answers YES to the question), this requires the customer to press a button on the machine that is clearly marked both with colour and optionally a distinctive design. The reverse vending machine then sends an automatic request 15 to a central database server 17 to be allocated lottery ticket numbers. In rare cases it may happen that the server cannot be accessed, and the customer will be presented with a message in the display on the reverse vending machine, which initiates 18 the printing 16 of a regular return value receipt, the decision block in this case giving just one option. This return value receipt may optionally also contain an explanation of why the customer received such a receipt despite his requesting a lottery ticket.

Provided that the database server is accessible, the server will ensure 19 that a ticket number is issued 20, and the reverse vending machine will within a few seconds have this confirmation transmitted back from the server 17 with information about the lottery tickets depending on the number of bottles or cans that have been staked. When the reverse vending machine receives the confirmation, a new message 21 to the customer appears in the display of the reverse vending machine asking that the purchase be confirmed. As indicated by a decision block, the customer may cancel the purchase and ask 23 the reverse vending machine to print out a regular return value slip. If the customer confirms the purchase, the reverse vending machine will initiate 24 the printing 25 of the lottery ticket for the customer. After this, confirmation that the lottery ticket has been printed is sent from the reverse vending machine, and is stored permanently in the database server.

With reference to FIG. 3, the invention will be explained in some more detail, reference also being made to the explanation relating to FIG. 1 above.

The database server 26 for the Lottery will through its connection to the reverse vending machine have continuous registration of sums that are staked on the Lottery, and from which reverse vending machine and at what time the sum was staked, as indicated by the reference numeral 27. This data must be compared regularly with data that the intermediary 8 collects 6 and sends to “Recyc.” 6. This may be done electronically by the intermediary 8 sending reports 28 to the Lottery 26. In order that the money staked on the Lottery should reach the operating company as indicated by the reference numeral 26, the shop must be invoiced 29 directly from the Lottery for all deposit sums that are staked on the Lottery. The operating company 26 is also responsible for payment 30 to the lottery winners (players) 31 and payment 32 to, e.g., a public cause or a charitable organisation 33, indicated in the figure by way of example by the abbreviation “ANF/VO”.

FIG. 4 shows a simplified block diagram of the system that is an integral part of the invention for ordering lottery tickets.

Incorporated in the reverse vending machine is known equipment 34 per se for recognition of and allocation of any return value (e.g., deposit value or material value) for returnable empty packaging that is inserted into an opening 35 in the reverse vending machine 7. A display 36 gives instructions to the customer and the reverse vending machine 7 is provided with an operating button 37 for selection of a standard receipt for a refund in cash, and an operating button 38 for selection of lottery ticket purchase. An optional “cancel button” 39 may be provided if the lottery ticket purchase is not to be implemented after the initial lottery ticket allocation, i.e., before a lottery ticket is printed out. A printer 40 is provided to print out either a standard receipt or a lottery ticket, both symbolised by the reference numeral 41. An interface 42, e.g., an A/D modem, encoder or non-dialled connection, connected to the reverse vending machine 7 communicates via connection 43, an interface 44, e.g., a signal transmitter or a telephone exchange, and connection 45 with a database server 46 in the operating company 26. The database server 46 is equipped to also be able to communicate with a database 47 containing an overview of the reverse vending machines that are included in the system. In addition to the reverse vending machine 7, other reverse vending machines, symbolised by RVMn, may be a part of the system, and will be connected via respective telephone connections, symbolised by TCn, to the database server 46 via the exchange 44 and the connection 45, wherein n=2, 3, 4 . . . m. m may be a multi-digit number, e.g., in the range of 10-5000, although these should not be understood as a limiting values for m.

It will be understood that the block diagram shown in FIG. 4 is to serve merely as an illustration of the many solutions that will be possible. It is also conceivable that the reverse vending machine and the database server communicate wirelessly, or that the reverse vending machine is connected to the central computer of the retailing chain and from there connected to the central database server.

The reverse vending machine will thus be equipped to receive both empty packaging that has a return value in the form of a deposit value and empty packaging with another return value. Other empty packaging that has no return value will pass through the reverse vending machine either as non-identifiable or as identified packaging, but without a return value. The said equipment 34 in the machine will thus not only, in a known way, recognise empty packaging with a deposit value and allocate a return value for such packaging, but will also identify characteristics of the empty packaging, with another return value, for example, related to characteristics selected from the group consisting of material type in general, colour of glass or plastic, plastic type, metal type(s), weight, shape, identifiers (for example, bar codes), and allocate any payable return value for such returned empty packaging.

FIG. 5a and FIG. 5b show how only a small change of the front of a traditional reverse vending machine will be necessary. The reference numerals are the same as those used in connection with FIG. 4. The reference numeral 48, however, relates to the feed-in opening for crates (not shown), provided the reverse vending machine is equipped with this feed-in option.

FIGS. 6 and 7 show two alternative suggested appearances of lottery tickets, where FIG. 7 shows a slightly more complete embodiment. However, it should be understood that the graphic design of the lottery ticket can vary substantially from the illustrated examples without thereby departing from the inventive idea.

It is possible that the player might wish to cancel his stake on the Lottery after receiving his lottery ticket, and the Lottery will make allowances for this. A cancel function may be web and/or telemarket based, where the player must enter the unique serial number and ticket number range in order to cancel the lottery ticket. Provided the lottery ticket is cancelled before the draw takes place, and the player returns the lottery ticket, the Lottery will be able to pay the sum staked into the player's bank account.

It may be expedient to use reverse vending machines with a thermal printer, although this should not be understood as a limitation. A physical lottery ticket proving that the customer has placed a stake should be printed. If there is a fault in the printer (either a technical fault or is simply out of paper), the customer will not receive a printed lottery ticket. This problem can be solved by registering the ticket in the database server on a temporary basis only until the reverse vending machine sends confirmation back to the database server that the ticket has been printed out. It is only then that the lottery ticket is registered permanently in the database. Today, the Applicant's reverse vending machines have functionality which allows them in the event of a fault (e.g., end of paper) to print out the last deposit slip as soon as the fault has been rectified. In the present case, it is expedient to have a time limit function, so that if the database does not receive confirmation within. e.g., 120 seconds, the lottery ticket is deleted from the database. In that case, the reverse vending machine prints out a return value slip even though the customer wanted a lottery ticket.

The design of the course of the game and the prize plan is determined to a large extent by the conditions set by the public “Lottery Inspectorate”, but it will of course be an advantage is the lottery could have a flexible prize plan, i.e., that prize allocation to each prize group is set as a proportion of the turnover, and not as a fixed sum. To ensure that the Lottery is more accessible when it comes to the announcement of prizes, it would be an advantage if the draw could be given publicity on television or possibly on text TV.

A ticket number range and a serial number or control code are allocated in real time by the database server. It is assumed that for the returnable packaging basis that exists in Norway, an 8-digit number will be sufficient. This means that at most 99 999 999 lottery ticket numbers can be sold for each draw. If the number of returned units indicates the need for a ticket number series with more digits, this is of course possible. Alternatively, lottery tickets could be issued in, e.g., letter-related series.

This calculation is based on 20% of all return value money going into the lottery, and each lottery ticket costing, e.g., 50 øre. Even if it is reckoned that an unrealistic 100% goes to the lottery, i.e., that all registered return value, i.e., both pure deposit value and other return value, is staked on the lottery, there would not be more that 49 million lottery tickets per draw. Thus, it is believed that in Norway an 8-digit lottery ticket number will suffice. It is uncertain what a realistic prize allocation would be, but it is a fact that higher prizes attract more players.

One of the main challenges of the lottery on the technical side is the communication between the database server and the reverse vending machines. There are several alternative communications solutions and these are to a large extent determined by three factors: a) the costs associated with the communication method, both installation and operation; b) security against unauthorised access; and c) other aspects of the running of the lottery.

It has been considered that suitable communication between database server and the reverse vending machines is an XML code sent over a TCP/IP network. In brief, this means that the communication takes place via the Internet between two specific IP addresses. This gives flexibility as regards selection of physical connection, and it is cost-effective to use Internet communication.

For the reverse vending machines to be able to communicate with a central database server which administers the Lottery, it is necessary for the reverse vending machine to be connected to either an analog modem, and ISDN adapter or a network card, depending on the communications solution that is chosen.

A dial-up analog connection requires the reverse vending machine to have its own telephone line and analog modem. Seen from the customer's point of view, a solution of this kind will give an excessively long response time between the database server and the reverse vending machine (15-20 seconds), and is therefore considered to be rather unsuitable.

A dial-up ISDN connection requires the reverse vending machine to have an ISDN card installed and be connected to an external ISDN line. The connection is established quickly and will give a faster response time between the database server and the reverse vending machine that an analog line. The reverse vending machine communicates via the Internet over a TCP/IP network, and once the line is established, the response from the database server will go relatively quickly. It is presumed that a lottery ticket could be printed out within 10 seconds from the customer confirming the purchase, which will probably be seen as within the bounds of what is acceptable. However, the transaction cost via the telephone network be a major, unfavourable cost element.

A GSM connection is not standard equipment in reverse vending machines today, and the response time when enquiries are made to a database server is comparably very long. In addition, this will lead to sizeable investments for the Lottery in the form of the installation of a GSM modem centrally on the recipient's side to be able to cope with many simultaneous calls, which makes a GSM solution prohibitively expensive.

Communication via an intranet in the retailing chain requires the reverse vending machines to have a network card installed and connected to the chain's network. Communication will then take place via the retailing chain's network and each machine is identified by an IP address. Today there are no reverse vending machines that have connection via the shops' intranet, but it is believed that the number of reverse vending machines using this form of external communication will increase in the next few years.

However, XML-based communication over a TCP/IP network in connection with the implementation of the present invention and with today's technology seems to be the most obvious solution, and will be able to handle communication over an intranet connection at a later stage. The cost per enquiry to the database server in such a solution will be almost zero for the Lottery and the shop in question, as in reality an already established communications solution will be used, but this will of course entail a number of installation challenges as regards route directors and firewalls.

ADSL or broadband transmission is an additional service for subscribers who require efficient transmission/reception of data via the telecommunications network. ADSL can be connected to both analog and digital lines (ISDN). The user does not pay a traffic fee (call units), just a fixed monthly cost. The ADSL modem supplied by the telecommunications operator runs parallel over the telecommunications network, and therefore does not block any incoming calls, even when in use. To be able to use ADSL communication, an ADSL modem must be connected to the existing telephone line to each reverse vending machine, and there are several advantages with this form of communication. Firstly, all the reverse vending machines are “always on”, i.e., that the reverse vending machine will be in constant contact with the Internet and thus be capable of communicating swiftly with the database server. The response time will be minimal and the customer will in practice not notice any difference timewise between taking out a standard return value slip or a lottery ticket in the Lottery. The disadvantage of ADSL is of course that it is an added cost for the shop because a subscription fee must be paid to the telecommunications operator for the ADSL line, although this fee may in time become lower or lower in a larger subscription agreement. In addition, ADSL lines are only available in and in the vicinity of large towns for the time being.

Another transmission possibility also resides in GPRS communication.

Based on today's technology, it therefore appears that the Lottery most effectively will support XML formatted data sent over a TCP/IP network.

The reason that the only focus is on a connection in real time can be explained by the need to ensure that all the lottery tickets bought are in fact included when the lottery is drawn. The requires the reverse vending machine to have confirmation that the lottery ticket is registered in the database.

Thus, the conclusion is that the choice of communications solution is in practice a choice between dial-up ISDN, ADSL or GPRS, and that the choice between them, from the cost aspect, is in reality an assessment of an anticipated participation in the Lottery per reverse vending machine per day. This will in turn be determined by the number of customers in the shop.

When a customer makes a lottery ticket purchase by pressing the ticket button 38 on the reverse vending machine 7, the reverse vending machine makes a request to the database 46 (external, central computer) for the allocation of lottery ticket numbers. This request sends the following information:
the identity of the reverse vending machine, e.g., a nine-digit ID code;
the time the stake was placed in a predefined format;
the sum of money staked in kroner in a predetermined format;
customer ID and optionally other identification of the customer.

The database server 46 will then send back the following information that is to be printed on the lottery ticket:
lottery ticket number series (with start and end number);
the serial number or control code of the lottery ticket;
the stake in kroner;
the number of tickets;
the time of the draw;
the deadline for playing the lottery;
the name of the public or charitable cause.

In addition, the lottery ticket may contain one or more graphic elements that are downloaded from the reverse vending machine (or from the database server) as required. For example, there may be seasonal variations (the Christmas lottery), or various campaigns (TV action, earmarked funds or the like). In these cases, there could be a standard text and/or logo etc.

When the lottery ticket has been printed out, the reverse vending machine will normally send confirmation thereof to the database server, and the lottery ticket number(s) can then be stored permanently in the database. However, it is conceivable that when the database server has supplied the lottery ticket data to the reverse vending machine, the transaction is disconnected, it then being assumed that the reverse vending machine will perform the remaining operation, i.e., the issuing of the lottery ticket.

Simultaneously with the lottery ticket purchase, there is the possibility that the database server could perform a cross-check with the reverse vending machine database, in which the ID of the reverse vending machine is checked against a site register so that the database server administering the lottery also knows which shop the ticket has been bought in. This is of interest in order to have an overview of the flow of money in the lottery system, and to be able to immediately identify where a customer has bought a winning ticket.

The design of the lottery ticket must be as simple as possible as everyone should be able to understand the information on the ticket, and at the same time the print size must not be too small. The ticket must contain a combination of both static and dynamic information, within the scope of what the technical printer is able to handle

With today's thermal printers, which have relatively good resolution, it is possible to print out bitmap files, which in practice means that images can be combined with dynamic information such as ticket numbers and the like. The lottery ticket can be printed out in both portrait and landscape format.

The graphic design of the lottery ticket can of course be varied, but it should contain the following dynamic information:
the serial number or control number of the ticket;
the deposit sum staked;
the number of tickets bought:
the ticket number range allocated;
information about deadline for playing the lottery and time of draw.

In addition, the ticket may contain:
an invitation to check the Lottery web pages;
information about the recipient of the profits;
general practical information.

Polite closing phrases and optionally other information (Jackpot, campaigns etc) could also be added.

All the lottery tickets contain both a serial number (control code) and a ticket number range. It is the lottery number that is drawn in the official draw, whilst the serial number is merely a control number to determine, e.g., which draw the ticket belongs to, and to check that the ticket is correct in relation to the ticket number range. The serial number is advantageously encrypted to prevent forgery. Thus, a player who finds a misplaced lottery ticket can check whether he has won via the Lottery web pages or an automatic telephone service, provided he has the correct serial number and ticket number range.

More complete examples of the design of a lottery ticket can be seen from FIG. 7.

It is anticipated that the Lottery will be a well-received, unregistered lottery along the lines of lotteries such as “Pengelotteriet” or the former “Gullfisken”. In other words, the organiser does not know the identity of those who have bought tickets. Therefore, the players themselves are responsible for claiming their prizes when they win, which in practice may lead to unclaimed prizes. Prizes may also be unclaimed because players forget to check their tickets or perhaps simply lose them. However, if the prizes are of a sufficient size relative to the sum staked and/or the chance of winning even small prizes is good, it is believed on the basis of experience with Pengelotteriet that people will be highly motivated to check their tickets after the draw. According to standard practice, unclaimed prizes should fall to the Lottery and its causes after three months and optionally be handed out as prizes in the next draw.

The problem of unclaimed prizes can be solved by insisting on registration of the players, so that their names are known when they buy their tickets. However, a registration process of this kind raises the threshold for participation in the lottery, so that it makes people less willing to take part. To collect a deposit on or return bottles is normally something that people do under “voluntary compulsion” to ease their conscience as regards the environment, and the personal anonymity in relation to the lottery therefore seems important. Player registration, as in LOTTO, should therefore be voluntary, since in reality it is the player's risk, The mounting of a card reader on the reverse vending machine would enable the customer who has a player card, or a bank card, credit card, or a retailing chain membership card, to the number of an account into which any prize he might win should be paid. Any account designation and card type could be given on the lottery ticket, so that the customer is able to see that the account number has been correctly identified. The requirement that prizes should be paid into a bank account, credit card account or other user account governs the requirement of any age limit for participation in the Lottery.

A factor that is of crucial importance for the credibility of the Lottery is the certainty that each ticket purchased will be entered in the draw. In practice, this means that it must be quite certain that all sold tickets are properly registered in the database when the draw takes place. The only satisfactory way of ensuring this is that all ticket numbers and serial numbers are allocated in real time by the database server, i.e., not by using a system that is randomly updated. This in turn means that all the reverse vending machines must be online during the shop's opening hours, i.e., during that time it is possible to place a stake on the Lottery. It is for this very reason that ADSL or dial-up ISDN represents a preferred communications solution. If the connection is disrupted for a period, the reverse vending machine will not receive the necessary confirmation from the database server and consequently will not accept participation in the lottery game, but will instead print out a regular deposit slip for a refund of the deposit in cash.

The credibility of the Lottery is also dependent upon all the tickets being unique, and that the threshold for forging tickets is as high as possible. Credibility is secured by assigning each ticket a unique encrypted control number (serial number) that is linked to the ticket number range, i.e., a from-to number that identifies a prize, and is also related to the draw date. It is difficult to prevent the copying of tickets 100%, but the threshold is nevertheless so high that the chances of this happening must be deemed minimal. All return value slips (for example, deposit slips) are printed out on thermal paper which is preprinted with the emblem of the supplier of the reverse vending machine on the back, or possibly the logo or name of the retailing chain. If it is to be possible to forge a winning ticket, the forger must possess a technical printer that prints with the same type font and graphics, he must have a piece of the original paper used in the printer, and he must have a winning ticket. The last item is necessary because each ticket is unique, and a lottery ticket containing a winning lottery number, but not a corresponding control code or serial number can thus easily be exposed. The chances of these three things happening simultaneously are minimal.

General data security is of course an essential aspect of the invention. Unauthorised access can take place at either end of a communication line, at the database server end and the reverse vending machine end, respectively. All external access naturally requires both a user name and password check, in addition to unauthorised access being prevented by installing a firewall and IP control. This last-mentioned involves the installation of a code in the software which means that the reverse vending machines and the database server only answer calls from one (or more) predefined IP addresses.

In an unregistered lottery, a number of administration costs are incurred in connection with the handling of prize payments, and this would not be the case if the players had been pre-registered. The scope of the prize payment task is largely determined by the prize structure and the number of players. A prize structure in which there are fewer, but larger prizes generates less administration than a prize structure with many small prizes.

Because all the reverse vending machines are connected to one database for the Lottery in real time, no matter what telecommunications technology is chosen, it is ensured that all lottery tickets are registered in the database at the time of their purchase, and thus all purchased tickets are entered in the draw. The communication between the reverse vending machine and database servers should, as already mentioned, take place in the form of an XML code sent over a TCP/IP network. A password, user name and IP control are entered at both ends of the communication line.

In the event that the telecommunications link between the reverse vending machine and the database server is disconnected for technical reasons, is not establishable within defined time margins, or for other reasons, it would be an advantage if the reverse vending machine could in fact issue tickets “off line”. In such a case a lottery ticket reserve could at all times be found in the machine, and the size of the ticket reserve could be based on, e.g., normal ticket sale frequency. The number sequence of the tickets is downloaded from the database server to a storage and ticket allocation unit 48 (FIG. 4) when the telecommunications link is in order. A serial number or control code package could also be downloaded from the database 46. The unit 48 may be constructed so that when a request for ticket purchase is confirmed, it a) allocates a number of ticket numbers corresponding to the return value sum owing the customer by the reverse vending machine, b) selects at random a serial number or a control code from the package, c) effects print-out of the ticket with the allocated ticket numbers, serial number or control code, date of draw etc., d) stores information about allocated ticket numbers with accompanying serial number or control code and date of draw, and passes this combined information to the database server 46 when the connection between the reverse vending machine and the database serve has been re-established.

As an alternative to a serial number or control code package being downloaded from the database server, it is also possible that the unit 48 itself, using an algorithm, optionally with parameters supplied by the database server, generates a serial number or control code.

What is important is that information about the lottery ticket numbers given to the customer together with a unique serial number (control code) for the ticket in question, and for a specific draw, is actually transferred to the database server in time for the draw. This means that the tickets which are allocated off-line (without direct connection to the database server) must have a time margin to the draw that is such that transfer to the database server is probable within that time, whether this happens when the ordinary data connection is active again or via another connection.

The Lottery does not involve the elements that are traditionally associated with the development of gambling dependency, but rather elements that stimulate environmental awareness linked to the return of empty packaging. There is no traditional stake consisting of money, but of empty packaging that is consciously returned to the shop. There is a considerable time lapse between stake and prize, and the actual “gaming device” (the reverse vending machine) does not cause any “elements of excitement”.

Although the description has been related in particular to the problems of empty beverage packaging, it will be understood that the invention could also be used for other empty return packaging suitable for the purpose, whether it is suitable for reuse or for recycling by remelting and reuse in the same or other areas of use.

It will also be understood that a reverse vending machine that only receives empty deposit-bearing packaging can be constructed, whilst another reverse vending machine is designed to receive only empty packaging that has no deposit value, but a return value related to, for example, the material type of the empty packaging. Thus, the customer must carry out an effective sorting of the empty packaging before introducing it into the machines. However, there is nothing to prevent a reverse vending machine from being able to receive both types of empty packaging, i.e., both that with and that without a deposit value, by, for example, giving all empty packaging without a deposit value, or only certain types thereof, a return value. Downstream of the reverse vending machine known sorting equipment per se may be provided for sorting, for example, empty packaging that has a deposit, empty packaging with a payable return value and empty packaging without any return value for remelting, material separation, reuse or destruction.

1. A method related to ordering lottery tickets in a lottery associated with a person's receipt of return value in trade in goods, establishing in connection with an order a communication link between a point-of-trade and a central, external database server (computer), information elements being transferred to the central database server, the information elements being registered in the database server, and communication being made back from the database server to the point-of-trade that lottery tickets have been allocated, characterized in
reserving a number of lottery tickets or shares in the lottery upon registration of information elements in the database server, and in addition communicating back from the database server to the point-of-trade such reservation together with other information elements, and
either: confirming through action from said person lottery ticket order to cause issuance of lottery ticket with lottery number(s) and serial number/control code, sending confirmation from the point-of-trade to the database server via the communication link that lottery ticket has been issued to the person, and storing actual lottery number(s) thereby in the database server,
or: issuing to said person a receipt for cash payment:
a) if through action of said person those in the database reserved lottery tickets or lottery shares are caused to be cancelled, or
b) upon failure in said communication link, and
using as point-of-trade a return vending machine for receiving empty packaging in the form of bottles and/or cans for beverages having said return value.

2. A method related to ordering lottery tickets in a lottery in association with a person's receipt of a return value in trade in goods, the return value usable for buying lottery tickets, a communication link in connection with an order intended to be established between a point-of-trade and a central, external database server (computer), where it is intended to transfer to the central database server information elements for registering in the database server and subsequent communication back from the database server to the point-of-trade that lottery tickets have been allocated, characterized in
using as the point-of-trade a return vending machine for receiving empty packaging like bottles and/or cans for beverages having a return value,
allocating from a local database in the return vending machine a lottery ticket based on the monetary value or the return value which has been staked and which corresponds to the return value of returned empty packaging, and with information applied upon the person's activation of a device on the return vending machine for desired purchase of lottery tickets and when a communication link between the return vending machine and a central, external database server (computer) arbitrarily cannot be established,
upon the established communication link transferring from the return vending machine to the central database server information elements elected from the group: return vending machine identity, time for stake, lottery number series, e.g. with start and end numbers, lottery tickets serial number or control code, monetary value of stake, number of lottery tickets, draw time, deadline for playing the lottery, person related identification, and
registering the information elements in the database server and adding to the lottery series of the lottery tickets to participate in a lottery draw.

3. A method as disclosed in claim 2, characterized in
pre-allocating the lottery ticket number series to the reverse vending machine when the reverse vending machine has a communication link with the database server; said the lottery ticket serial number or control code either being allocated randomly from a serial number/control code package downloaded in the reverse vending machine from the database server, or generated locally in the reverse vending machine using an algorithm.

4. A method as disclosed in claim 1, characterized in
establishing the communication line via a TCP/IP network.

5. A method as disclosed claim 1, characterized in
checking in the database server the identity of the reverse vending machine against an identity-related address register to be able to announce where winning lottery tickets have been issued.

6. A method as disclosed in claim 1, characterized in
that the serial number or control code of the ticket is unique to the issued lottery ticket.

7. A method as disclosed in claim 6, characterized in
that the control code is generated non-serially in the database server.

8. A method according to claim 1, characterized in
that the information elements are selected from the group consisting of:
the identity of the reverse vending machine,
the time of the stake
the monetary value of the stake, which corresponds to the return value of the returned empty packaging,
customer-related identification;
a ticket number series, e.g. with start and end number,
the serial number or control code of the ticket
the monetary value of the stake,
the number of tickets,
the time of the draw,
the deadline for playing the lottery,
graphic elements,
optional guiding information.

9. A system related to ordering lottery tickets in a lottery associated with a person's receipt of return value upon trade in goods, where the return value can be used for purchase of lottery tickets, wherein in connection with the ordering there is established a communication link between a point-of-trade and a central, external database server (computer), wherein there is transferred to the central database server information elements, wherein information elements are registered in the database server, and wherein there is communicated back from the database server to the point-of-trade that lottery tickets have been allocated, characterized in
that the point-of-trade is a return vending machine for return of empty packaging, such as e.g. bottles and/or cans for beverages,
registration and reservation means in the database server which upon registration of information elements being capable of reserving a number of lottery tickets or shares in the lottery and in addition communicating back to the point-of-trade such reservation together with other information elements,
operating means on the return vending machine designed to receive from the person confirmation action of lottery order,
means in the return vending machine capable of causing either: confirmation to be sent from the point-of-trade to the database server via the communication link that lottery tickets are issued to the person, to store in the database server actual lottery number(s), or: issuance of a receipt for cash payment if a) said person instead chooses through activation of operating means on the return vending machine to cancel those in the database server reserved lottery tickets or lottery shares or b) upon failure in said communication link.

10. System related to ordering lottery tickets in a lottery associated with a person's receipt of a return value in trade in goods, wherein the return value can be used for lottery ticket purchase, wherein in connection with the ordering there is intended to be established a communication link between a point-of-trade and a central, external database server (computer), and wherein it is intended to be transferred to the central database server information elements for registering in the database server and subsequent communication back from the database server to the point-of-trade that tickets have been allocated, characterized in
that the point-of-trade is a return vending machine for receiving empty packaging such as bottles and/or cans for beverages,
that operating means are located on the return vending machine to receive confirmation from the person about required purchase of lottery tickets when a communication link between the return vending machine and a central, external database server (computer) arbitrarily is not to be established,
allocating means in the return vending machine to allocate from a local database in the return vending machine a lottery ticket based on the monetary value or the return value which has been put at stake and which corresponds to the return value of the returned empty packaging, and with information applied thereon,
transfer means in the return vending machine adapted to upon re-established communication link to transfer from the return vending machine to the central database server information elements elected from the group: return vending machine identity, time of the stake, lottery ticket number series, e.g. which start and end number, lottery ticket serial number or control code, monetary value of the stake, number of tickets, time of the draw, deadline for playing the lottery, person related identification, and
registering means in the database server which registers the information elements and supplies the lottery series to the lottery tickets to a participate in the lottery draw.

11. A system using a return vending machine to handle a return value of empty packaging, e.g. empty packaging in the form of bottles, cans or containers for beverages and nutrition means, wherein the return vending machine has first and second devices for letting a person indicate either by activating the first device that there is to be issued a receipt related to the return value of the empty packaging for subsequent cash payment from the receiver of the empty packaging, or by activating the second device that the return value of the empty packaging is to be used in a different way, characterized in
ordering means in the return vending machine which upon the activation by the person of the second device is capable of ordering participation in a lottery with a number of lottery tickets related to return values of the empty packaging, and to activate via a communication line a link to a central database server (computer), and
issuing means for upon a registered communication failure in the link with the database server instead to issue a receipt for cash payment.

12. System related to ordering lottery tickets in a lottery associated with a person's receipt of a return value in trade in goods, wherein the return value can be used for lottery ticket purchase, wherein in connection with the ordering there is intended to be established a communication link between a point-of-trade and a central, external database server (computer), wherein it is intended to be transferred to the central database server information elements for registering in the database server and subsequent communication back from the database server to the point-of-trade that tickets have been allocated, characterized in
that the point-of-trade is a return vending machine for receiving empty packaging, such as bottles and/or cans for beverages,
operating means means in the return vending machine which can be activated by the person, said means being capable upon non-establishable communication link between the return vending machine and a central, external database server (computer) to allocate to the person from a local database in the return vending machine a lottery ticket based on:
return value which has been put at stake and which corresponds to the return value of the returned empty packaging, and with information applied,
issuing means in the return vending machine for issuing the lottery ticket,
transfer means in the return vending machine which upon re-established communication link enables transfer to the central database server of information elements, and
registering means in the database server to enable registration of information elements and to supply the lottery series to the lottery tickets to participate in a lottery draw.

13. A system as disclosed in claim 12, characterized in
that the reverse vending machine has a unit designed to receive pre-allocated lottery ticket number series from the database server when the reverse vending machine has a communication link with the database server; and
that said unit is capable of receiving a download from the database server of a lottery ticket serial number or control code package and to allocate issued lottery tickets serial numbers or control code selectably, e.g., randomly from the package, or generated locally in the reverse vending machine using an algorithm.

14. A system as disclosed in claim 9, characterised in
that the serial number or control code that is provided on the lottery ticket is a code that is unique to the issued lottery ticket.

15. A system as disclosed in claim 14, characterised in
that the serial number or control code is generated non-serially.

16. A system as disclosed in claim 9, characterised in
that the issuing means is a printer, e.g., a thermal printer.

17. A system as disclosed in claim 9, characterized in
that the information elements are selectable from the group of: return vending machine identity, time of stake, lottery ticket number series, e.g. with start and end number, lottery ticket serial number or control code, monetary value of the stake, number of tickets, the time of the draw, the deadline for playing the lottery, customer related identification, graphic elements, optional guiding information.

18. A system as disclosed in claim 10, characterised in
that the serial number or control code that is provided on the lottery ticket is a code that is unique to the issued lottery ticket.

19. A system as disclosed in claim 10, characterised in
that the issuing means is a printer, e.g., a thermal printer.

20. A system as disclosed in claim 10, characterized in
that the information elements are selectable from the group of: return vending machine identity, time of stake, lottery ticket number series, e.g. with start and end number, lottery ticket serial number or control code, monetary value of the stake, number of tickets, the time of the draw, the deadline for playing the lottery, customer related identification, graphic elements, optional guiding information.

21. A system as disclosed in claim 11, characterised in
that the serial number or control code that is provided on the lottery ticket is a code that is unique to the issued lottery ticket.

22. A system as disclosed in claim 11, characterised in
that the issuing means is a printer, e.g., a thermal printer.

23. A system as disclosed in claim 11, characterized in
that the information elements are selectable from the group of: return vending machine identity, time of stake, lottery ticket number series, e.g. with start and end number, lottery ticket serial number or control code, monetary value of the stake, number of tickets, the time of the draw, the deadline for playing the lottery, customer related identification, graphic elements, optional guiding information.

24. A system as disclosed in claim 12, characterised in
that the serial number or control code that is provided on the lottery ticket is a code that is unique to the issued lottery ticket.

25. A system as disclosed in claim 12, characterised in
that the issuing means is a printer, e.g., a thermal printer.

26. A system as disclosed in claim 12, characterized in
that the information elements are selectable from the group of: return vending machine identity, time of stake, lottery ticket number series, e.g. with start and end number, lottery ticket serial number or control code, monetary value of the stake, number of tickets, the time of the draw, the deadline for playing the lottery, customer related identification, graphic elements, optional guiding information.

27. A method as disclosed in claim 2, characterized in
establishing the communication line via a TCP/IP network.

28. A method as disclosed claim 2, characterized in
checking in the database server the identity of the reverse vending machine against an identity-related address register to be able to announce where winning lottery tickets have been issued.

29. A method as disclosed in claim 2, characterized in
that the serial number or control code of the ticket is unique to the issued lottery ticket.

30. A method according to claim 2, characterized in
that the information elements are selected from the group consisting of:
the identity of the reverse vending machine,
the time of the stake
the monetary value of the stake, which corresponds to the return value of the returned empty packaging,
customer-related identification;
a ticket number series, e.g. with start and end number,
the serial number or control code of the ticket
the monetary value of the stake,
the number of tickets,
the time of the draw,
the deadline for playing the lottery,
graphic elements,
optional guiding information.
